(19) United States
(12) Patent Application Publication
(10) Pub. No.: US 2013/0062796 A1
(43) Pub. Date: Mar. 14, 2013

(54) Method for Fabrication of an Optically Transparent and Electrically Conductive Structural Material

(71) Applicant: Christopher S. Coughlin, Leonardtown, MD (US)

(72) Inventor: Christopher S. Coughlin, Leonardtown, MD (US)

(21) Appl. No.: 13/231,992

(22) Filed: Sep. 14, 2011

(51) Int. Cl. B29D 11/00

(52) U.S. Cl. 264/1.7

(57) ABSTRACT

A method for fabrication of an optically transparent and electrically conductive structural material, that includes electrospinning a nanofibrillar mat of a polymer, casting a conductive material nanowire network onto the electrospun mat, embedding the electrospun mat containing the conductive material nanowire network into a mold with bulk monomer, and polymerizing the bulk monomer with the embedded electrospun mat containing the conductive material nanowire network to create an optically transparent and electrically conductive polymer.

### STATEMENT OF GOVERNMENT INTEREST

The invention described herein may be manufactured and used by or for the Government of the United States of America for governmental purposes without payment of any royalties thereon or therefor.

### BACKGROUND

The present invention relates to a method for the fabrication of an optically transparent and electrically conductive structural material. More specifically, but without limitation, the present invention relates to the fabrication of a polymeric, conductive optical transparency system, especially for use in aircraft applications.

A transparency system is typically defined, but without limitation, as a system or apparatus that permits the passage of radiation. An optical transparency system is more specifically defined, but without limitation, as an optical system or apparatus that permits the transmittance of electromagnetic radiation in the visible wavelength range. In aircraft, a transparency system includes, but without limitation, canopies and windows. These systems must be highly durable and lightweight, specifically in military applications. Current U.S. Naval Aviation transparency systems are constructed of acrylic, polycarbonate or composites thereof, which often contain an imbedded conducting layer of either ultra thin gold or Indium Tin Oxide for electrostatic discharge protection and radar cross section reduction. The conducting layer needs to be ultra thin so as not to diminish the high optical transparency required in the canopy and/or window, as gold and Indium Tin Oxide are optical absorbers in bulk form. Typically, the transparency system is multilayered with numerous interfaces between unlike materials. Delamination (splitting into layers) frequently occurs at the metal film/polymer interfaces due to various environmental exposure effects while in service. This delaminated or debonded area acts as an optical scattering center, which degrades the optical transparency of the system. Delamination areas require costly repair or replacement of the aircraft transparency system (typically a canopy or a window). In the current state of the art, an Indium Tin Oxide thin film is applied to a polymeric substrate through a sputtering process. The resultant Indium Tin Oxide film is optically clear and conductive, but it must be further protected with a polymeric topcoat due to its poor environmental and abrasion resistance. The multiple interfaces between layers create areas of potential delamination that can lead to debond failures and subsequent degradation in optical transparency.

Thus, there is a need in the art to provide a method for fabrication of transparencies that incorporates the listed benefits without the limitations inherent in present methods.

### SUMMARY

The present invention is directed to a method for fabrication of an optically transparent and electrically conductive structural material, that includes electrospinning a nanofibrillar mat of a polymer, casting a conductive material nanowire network onto the electrospun mat, embedding the electrospun mat containing the conductive material nanowire network into a mold with bulk monomer, and polymerizing the bulk monomer with the embedded electrospun mat containing the conductive material nanowire network to create an optically transparent and electrically conductive polymer.

It is a feature of the invention to provide a method to fabricate an optically transparent and electrically conductive structural material that can be used in transparency systems and would create a transparency system that is more durable than currently used systems. Additionally, this structural material would minimize scratches, rain erosion, and other environmental degradation in the transparency system.

It is a feature of the invention to provide a method to fabricate an optically transparent and electrically conductive structural material that minimizes large area interfaces, therefore minimizes potential delamination at these interfaces, especially in an aircraft environment.

It is a feature of the invention to provide a method to fabricate an optically transparent and electrically conductive structural material that would eliminate any discrete interface that would be susceptible to delamination.

It is a feature of the invention to provide a method to fabricate an optically transparent and electrically conductive structural material that is both optically clear and electrically conductive.

### BRIEF DESCRIPTION OF THE DRAWINGS

These and other features, aspects and advantages of the present invention will become better understood with reference to the following description and appended claims, and accompanying drawings wherein:

FIG. 1 is a schematic of an embodiment of the method to fabricate an optically transparent and electrically conductive structural material.

### DESCRIPTION

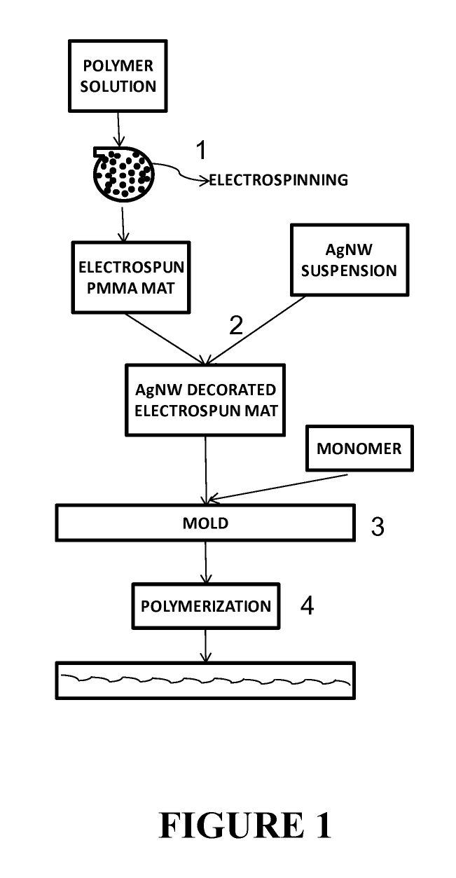

The preferred embodiment of the present invention is illustrated by way of example below and in FIG. 1. As seen in FIG. 1, the method for fabrication of an optical transparent and electrically conductive structural material includes electrospinning a nanofibrillar mat of a polymer, casting a conductive material nanowire network onto the electrospun mat, embedding the electrospun mat containing the conductive material nanowire network into a mold with bulk monomer, and polymerizing the bulk monomer with the embedded electrospun mat containing the conductive material nanowire network to create an optically transparent and electrically conductive structural polymer system.

In the discussion of the present invention, the invention will be discussed in a military aircraft environment, particularly as applied to a U.S. Navy aircraft transparency system; however, this invention can be utilized for any type of need that requires an optically transparent and electrically conductive structural material.

Electrospinning is related to the electrospray atomization process (atomization may be defined as breaking up a liquid into a fine spray or fog) which exploits the interactions between an electrostatic field and conducting fluid. In electrospinning, the viscosity and surface tension of the solution are adjusted so that the stream does not break into separate particles, as in the electrospraying, but remains as a stream allowing the formation of extremely fine fibers or nanofibers. The preferred electrospinning methods are described in U.S. Pat. No. 6,713,011 issued to Chu et al. on Mar. 30, 2004, and U.S. Patent Application Publication 2003/0137083 by Ko et al. published Jul. 24, 2003. Neither reference is admitted to be prior art with respect to the present invention by its mention in the description. Both the aforementioned patent and published patent application are incorporated by reference herein.

A nanofibrillar mat of a polymer is a material made of densely tangled or adhering filaments, fibers, or strands made of polymer. The size of the fibers or filaments is applicable to nanotechnology, usually cited as 1-100 nanometers.

The preferred polymer for electrospinning the nanofibrillar mat is poly(methyl methacrylate) (PMMA), which is also the structural material of the final Navy aircraft transparency system. Other polymers may be employed but they must be selected so that they are suitable for electrospinning for mat preparation and do not degrade the final optical properties of the composite when incorporated into the poly(methyl methacrylate) matrix. In the preferred embodiment, the nanofibrilar mat of a polymer is made by the described below method. A PMMA solution is created by dissolving PMMA polymer in a suitable solvent with heat and agitation. In the preferred embodiment, the solvent is N-N-dimethyl formamide, and the polymer is dissolved at a final concentration of about 10-25% by weight. The PMMA solution is placed in a syringe tipped with a blunt stainless steel needle suspended above a grounded conductive substrate. In the preferred embodiment, the needle is suspended about 5 inches above the substrate. A high voltage source is connected to the needle, and a voltage is applied, typically about 18 kV. During electrospinning, nanofibrils are ejected from the tip of the needle and deposited on a substrate. The substrate may be any conductive material such as, but without limitation, aluminum foil. Electrospinning is continued until a mesh of nanofibrils is collected on the substrate. In the preferred embodiment, the mesh is spun onto a filter material. The filter material may be mixed cellulose esters, but can be any filter material practicable. After the conductive material nanowire network is formed or cast on the mat, the filter material may be peeled away.

The conductive material nanowire network may be cast by preparing a dilute suspension of the conductive nanowire material in a suitable carrier solvent and filtering that suspension through the previously prepared nanofibrillar mat. In the preferred embodiment silver nanowire would be suspended in a blend of water and isopropanol of about 20% isopropanol by volume as a carrier solvent. The concentration of nanowire in the suspension depends on the area over which deposition occurs and is set so that the resulting nanowire network has a final areal density of from about 10 to about 400 mg/m². The volume of suspension is determined by the need to maintain a very dilute suspension for filtration and is typically selected to provide a suspension concentration in the range of about 1×10⁻⁵ to about 1×10⁻³ g/L of nanowire. The dilute nanowire suspension is filtered through the previously prepared nanofibrillar mat using mild vacuum. Upon completion of filtration, the mat is dried in air.

The preferred conductive material is silver nanowire. However, any type of conductive material (such as, but without limitation, gold or nickel nanowire) that is practicable can be utilized. Silver nanowire may be obtained commercially or prepared according to the method described in “Crystalline Silver Nanowires by Soft Solution Processing,” Y. Sun, B. Gates, B. Mayers, and Y. Xia, Nano Letters, vol. 2, no. 2, pp 165-168, 2002. In this method, platinum chloride is dissolved in ethylene glycol to provide seed crystals for nanowire growth. A solution of silver nitrate and poly (vinyl pyrrolidone) in ethylene glycol is added with heat and stirred for a fixed time. Centrifugation of the reaction mixture yields the nanowires in the isolated solids.

After the conductive material nanowire network is cast on the electrospun mat, the substrate can be peeled or removed from electrospun mat containing the conductive material nanowire network (or vice versa). The electrospun mat containing the conductive material nanowire network can then be placed in a mold suitable for bulk polymerization of methyl methacrylate for optical uses. The preferred mold has glass surfaces in contact with the monomer methyl methacrylate to create a highly polished surface. Bulk methyl methacrylate monomer, along with suitable additives for the initiation of polymerization, such as benzoyl peroxide or 2,2′-azobis(2-methylpropionitrile), is added to the mold and encapsulates the electrospun mat containing the conductive material nanowire network. The monomer is then polymerized to create a composite of conductive material nanowire network embedded in a poly(methyl methacrylate) polymer.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment contained herein.

What is claimed is:

1. A method for fabrication of an optical transparent and electrically conductive structural material, the method comprising:
electrospinning a nanofibrillar mat of a polymer;
casting a conductive material nanowire network onto the electrospun mat;
embedding the electrospun mat containing the conductive material nanowire network into a mold with bulk monomer; and,
polymerizing the bulk monomer with the embedded electrospun mat containing the conductive material nanowire network to create an optically transparent and electrically conductive polymer.

2. The method of claim 1, wherein the polymer for the nanofibrillar mat is made from poly(methyl methacrylate) (PMMA).

3. The method of claim 2, wherein the conductive material is silver nanowire.

4. The method of claim 3, wherein the bulk monomer is methyl methacrylate.

5. The method of claim 4, wherein the nanofibrillar mat is fabricated by creating a PMMA solution, placing the PMMA solution in a syringe suspended above a grounded conductive substrate, the syringe tipped with a blunt needle, applying a voltage to the PMMA solution, ejecting nanofibrils from the needle and depositing them on the substrate during electrospinning, and continuing until a mesh of nanofibrils is collected on the substrate.

6. A method for fabrication of an optical transparent and electrically conductive structural material, the method comprising:
electrospinning a nanofibrillar mat of a polymer, the nanofibrillar mat is fabricated by creating a poly(methyl methacrylate) (PMMA) solution, placing the PMMA solution in a syringe suspended above a grounded conductive substrate, the syringe tipped with a blunt needle, applying a voltage to the PMMA solution, ejecting nanofibrils from the needle and depositing them on the substrate during electrospinning, and continuing until a mesh of nanofibrils is collected on the substrate;
casting a conductive material nanowire network onto the electrospun mat, the conductive material nanowire network is cast by preparing a dilute suspension of the conductive nanowire material in a carrier solvent and filtering the suspension through the electrospun nanofibrillar mat;
embedding the electrospun mat containing the conductive material nanowire network into a mold with bulk monomer; and,
polymerizing the bulk monomer with the embedded electrospun mat containing the conductive material nanowire network to create an optically transparent and electrically conductive polymer.

7. The method of claim 6, wherein the conductive material nanowire network is cast on the electrospun mat by suspending silver nanowire in a blend of water and isopropanol thereby creating a nanowire suspension, and filtering the nanowire suspension through the electrospun nanofibrillar mat.

8. The method of claim 7, wherein after casting the conductive material nanowire network onto the electrospun mat, the substrate is removed from the electrospun mat containing the conductive material nanowire network.

9. The method of claim 8, wherein the PMMA solution is created by dissolving PMMA polymer in a solvent by heat and agitation.

10. The method of claim 9, wherein the solvent is N-N-dimethyl formamide.

11. The method of claim 10, wherein the polymer is dissolved at a final concentration of about 10-25% by weight.
